(19) United States
(12) Patent Application Publication
(10) Pub. No.: US 2004/0260946 A1
(43) Pub. Date: Dec. 23, 2004

(54) User not present

(76) Inventors: Conor P. Cahill, Waterford, VA (US); Christopher Newell Toomey, Cupertino, CA (US)

Correspondence Address: GLENN PATENT GROUP, 3475 EDISON WAY, SUITE L, MENLO PARK, CA, 94025, US

(21) Appl. No.: 10/600,121

(22) Filed: Jun. 20, 2003

(51) Int. Cl. H04L 9/00

(52) U.S. Cl. 713/201

(57) ABSTRACT

A method and apparatus is provided for invoking authenticated transactions on behalf of a user when the user is not present. For example, the invention allows a subscription to take actions that would otherwise require authentication, such as performing collections from a wallet, when the user is not present. Thus, the invention provides a form of delegation of authority.

### BACKGROUND OF THE INVENTION

1. Technical Field

The invention relates generally to authentication. More particularly, the invention relates to a system and method for authenticating a user when the user is not present, for example, for letting an agent act on a client's behalf.

2. Description of the Prior Art

In a typical e-commerce computing environment or, specifically in any computer system with which a client performs transactions, identification and authentication mechanisms are essential for identifying and authenticating the client requesting usage of system resources. A common implementation of an authentication mechanism uses a user identification (ID) along with a password. Thus, in this way, a client is accountable for the use of such system resources.

Consider an example of a user surfing the World Wide Web (Web) and desiring to purchase an item from a particular vendor's Web site. Referring to FIG. 1, a schematic diagram of main components according to the prior art, the client, referred to herein as a Principal 102, logs onto the Principal's service provider 104 for accessing the Web. In this example, after searching many sites, the Principal 102 chooses to purchase an item from a Vendor's Web site 106. The service provider 104 and the Vendor's Web site 106 are shown connected as they appear that way from the point of view of the Principal 102. In this example, the Principal 102 acts as a principal entity going to the Principal's wallet 108 to retrieve information needed by the Vendor's site 106 in order to complete the transaction. It could be that the user represented by the Principal 102 physically opens up the user's real-life wallet, pulls out a credit card, and enters the credit card number, expiration date, and other relevant data into the Vendor's Web site 106 application. The Principal 102 also could be copying and pasting from an online account. The Principal 102 could be providing account information to the Vendor's Web site 106 by a variety of means. It should be appreciated that in this example neither the service provider 104 nor the Vendor's Web site 106 has a session open with the Principal's wallet 108.

FIG. 2 illustrates another example of the Principal 102 completing a transaction with a Vendor's Web site 202. In this example, the Principal 102 buys an item from the Vendor's Web site 202, which stores previously entered relevant transaction data in an internal wallet account 204 of the Principal 102. It should be appreciated that the vendor's Web site is limited to obtaining payment information only from data stored on its own system. That is, the vendor's Web site cannot obtain payment information of the Principal 102 from another Web site.

Referring to FIG. 3, suppose the service provider 104 is part of a portal or federation relationship 306 which also comprises the Vendor Web site 302 and the Principal's wallet application 304, possibly on another Vendor's Web site. Typically, the Principal 102 identifies itself to the Wallet application 304 by using credentials passed on by the service provider 104, so that the Wallet 304 knows that the Principal 102 is present. Another way to look at this is the service provider is not allowed to obtain information about the Principal 102 dynamically. Only if the Principal 102 by some means such as using credentials, actually goes to the Wallet's site 304, can the service provider 104 attempt to transact with the Wallet 104.

Again, referring to FIG. 3, suppose the service provider 104 on behalf of the federation relationship happens to sell subscriptions, such as magazine subscriptions, on Vendor's Web site 302. Suppose further that the service provider 104 then desires to be able to automatically renew subscriptions. To automatically renew subscriptions, it would be advantageous to allow the service provider 104 to charge the Principal's Wallet account 304 at times when the Principal 102 isn't present.

Another example is an airline wanting to update a calendar service with information about a user's flight being delayed. If the user is on the plane, then the likelihood is that the user is not present at the Web site that keeps track of such type of information, and, thus, the user is not going to be able to participate in that transaction. It would be advantageous to allow the user to be able to control an entity that is able to participate in that transaction.

It would be advantageous for a service provider and similar entities to be granted permission to perform a transaction in a user's absence.

Some prior art techniques address security, but do not address user not present. Kyung-Ah Chang, Tae-Seung Lee, Bang-Hun Chun, and Tai-Yun Kim, Ticket Based Secure Delegation Service Supporting Multiple Domain Models; Proceedings of 2001 Pacific Rim International Symposium on Dependable Computing; Dec. 17-19, 2001 describe proposing a ticket-based delegation service for multiple domain models. Their scheme presents an extension to the Kerberos (J. T. Kohl et al., 1991) framework using public key cryptosystem (T. ElGamal, 1985). This proposed model, based on CORBAsec (A. Alireza et al., 2000; B. Blakey, 2000), supports the protection of the high-level resources and the preservation of the security policies of the underlying resources that form the foundation of various domains, between the Kerberized domains and the nonKerberized domains. They claim to achieve flexibility of key management and reliable session key generation between the client and the provider using the public key cryptosystem based ticket.

B. C Neuman, and J. G. Steiner, Authentication of Unknown Entities on an Insecure Network of Untrusted Workstations, Proceedings UNIX Security Workshop; Aug. 29-30, 1988 describe needing a method to authenticate users wishing to access network services. Their method had to be secure in the given environment, but not unduly cumbersome for the user. Their approach taken was based on a cryptographic protocol by Needham and Schroeder (1978). An authentication server known as Kerberos runs on a trusted computer. Kerberos knows the passwords (encryption keys) for each user under its authority. It also shares a key with each server. When a program running on a workstation wishes to prove the identity of its user to a given network server, it contacts Kerberos and asks for a ticket for that server. The ticket is returned to the workstation encrypted in the server's key, and then again in the user's key. The user's password is used to decrypt the ticket which can then be passed to the server to prove the user's identity.

Bill Doster, and Jim Rees, Third-Party Authentication in the Institutional File System, Feb. 2, 1992 describes the use of intermediate translators in an Institutional File System that presents the problem of authenticating the translator to the file server where the client's private key is not known to the translator. Doster and Rees have implemented a modification to the Kerberos authentication exchange that allows their translators to securely acquire the rights necessary for the translators to access files and other services on behalf of their clients. They attempt to solve the problem of non-Unix clients obtaining the file services of a Kerberos authentication system from translators that translate Institutional File System (IFS) services into services the client can understand. They introduce intermediate authentication service for the translator to authenticate itself to the IFS server in such a way that it can perform file system operations on behalf of the client. However, such technique still requires the client to be present, for there to be an active session with the client.

### SUMMARY OF THE INVENTION

A method and apparatus is provided for invoking authenticated transactions on behalf of a user when the user is not present. For example, the invention allows a subscription to take actions that would otherwise require authentication, such as performing collections from a wallet, when the user is not present. Thus, the invention provides a form of delegation of authority.

### BRIEF DESCRIPTION OF THE DRAWINGS

FIG. 1 is a high level schematic diagram of main components according to a prior art system;

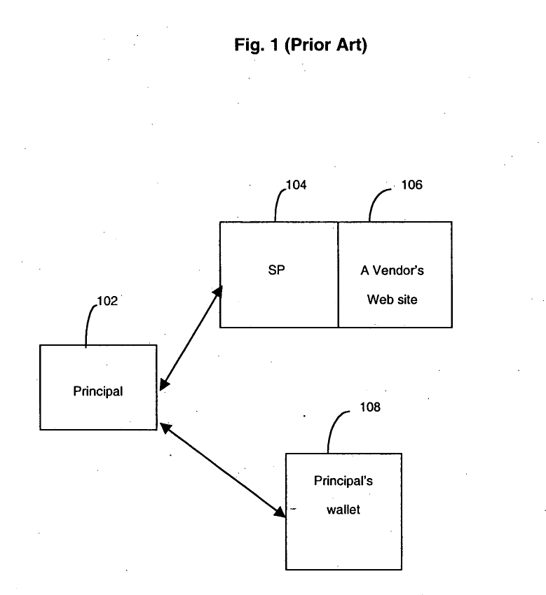

FIG. 2 is a high level schematic diagram of main components according to another prior art system;

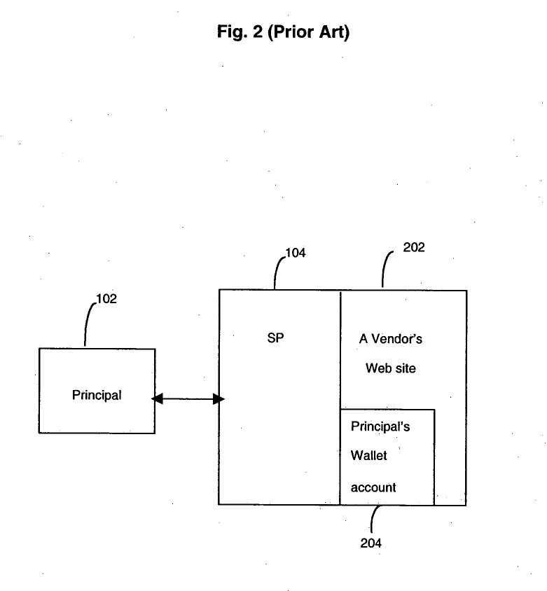

FIG. 3 is a high level schematic diagram of main components according to another prior art system; and

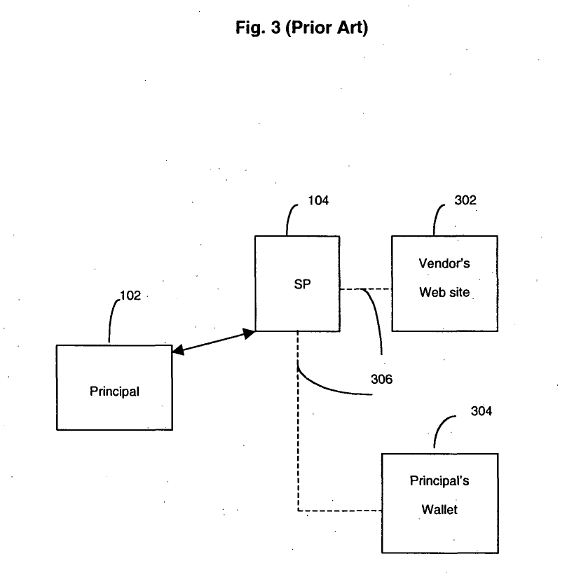

FIG. 4 is a high level schematic diagram of main components and features according to the invention.

### DETAILED DESCRIPTION OF THE INVENTION

A method and apparatus is provided for invoking authenticated transactions on behalf of a user when the user is not present. For example, the invention allows a subscription to take actions that would otherwise require authentication, such as performing collections from a wallet, when the user is not present. Thus, the invention provides a form of delegation of authority.

In the preferred embodiment of the invention, at a time when the user is present, a service provider essentially asks the user if the service provider can perform a certain transaction at a later point in time when the user is not present. If the user says, “Yes,” then the service provider sends a notification to register with either of, or with both of a trusted discovery service (DS) and the Web Service Provider (WSP) which performs the requested transaction. At this point and while the user is still present, the user can be asked to provide informational content related to the transaction. Thus, the permission to perform a requested transaction for when the user is not present is registered with any of the following: the DS alone, the WSP alone, or both the DS and the WSP. In essence, the registration indicates to the DS and to the WSP that the user gave the service provider permission to initiate the transaction in the user's absence and on the user's behalf.

For invocation, when the service provider makes a request to enact the transaction at hand, it first contacts the DS. Technically speaking, the service provider makes a request via client software representing the user, referred to herein as the Web Service Client (WSC). The DS knows where to locate the WSP performing the transaction. At this point, which can be viewed as an invoke control point, the DS can check if the user gave permission for contacting the WSP when the user is not present. If permission was granted and control goes to the WSP, then, as the WSP is accessed to perform the given transaction, the WSP can do two things. The WSP can trust the DS and accept that if the DS said the user gave permission, then the WSP performs the transaction. Or, the WSP can decide to do the checking for permission itself, regardless if the DS did a prior check or not, and subsequently perform the transaction if the WSP discovers itself that permission was granted.

It should be appreciated that in another embodiment, only the DS is sent a notification of registration. In another embodiment, only the WSP is sent a notification of registration.

In one preferred embodiment of the invention, the discovery service returns to the service provider (or WSC) a ticket, which the service provider uses when the user isn't present to interact with the WSP. The ticket serves as proof that the user gave permission to the service provider to act on the user's behalf when the user is not present.

In another equally preferred embodiment, information representing the fact that the user gave permission to the service provider to act on the user's behalf is recorded in any of the DS, the WSP, and the service provider, such as in a table format.

It should be appreciated that in the preferred embodiment of the invention, a user is provided the capability of reviewing and modifying stored permissions. For example, suppose the WSP is a wallet. Then, a user may decide to change a particular permission setting and not allow a particular entity access to the user's wallet anymore.

It should further be appreciated that the invention advantageously provides more robust security by having trust kept centrally in the discovery service, rather than having trust spread out in multiple places. When the lifetime of a ticket extends beyond a particular time period, such as a few hours, for example, and especially beyond 24 hours, it becomes necessary to provide a means for invalidating the ticket in some way. On the smaller timeframe of the life of a ticket, the window of opportunity to have to invalidate a ticket is much smaller and the risk therefore is low. The requirement to invalidate a ticket can require work on the part of the service provider/WSC, the WSP, and the user. Furthermore, invalidating a ticket would also require that the WSP be relied upon to do the right thing, e.g. checking that a ticket is cancelled before it grants access because of it. Such checking puts a heavy trust reliance on the implementation at the WSP. Whereas according to a preferred embodiment of the invention, invalidating a ticket need only involve the discovery service. The preferred embodiment of the invention has and leverages a heavy trust reliance on the central discovery service, a service in which the user already has a higher level of trust.

It should be appreciated that the discovery service provides means for supporting users having different WSP(s) accessed by different WSP applications, even though the users may share the same service provider. For example, one user could have a Citibank wallet, another could have a MasterCard wallet, and another could have an AOL wallet. That is, the preferred embodiment of the invention provides architecture to support every user having a different wallet through use of the discovery service, which keeps track of such user information.

An Exemplary Implementation

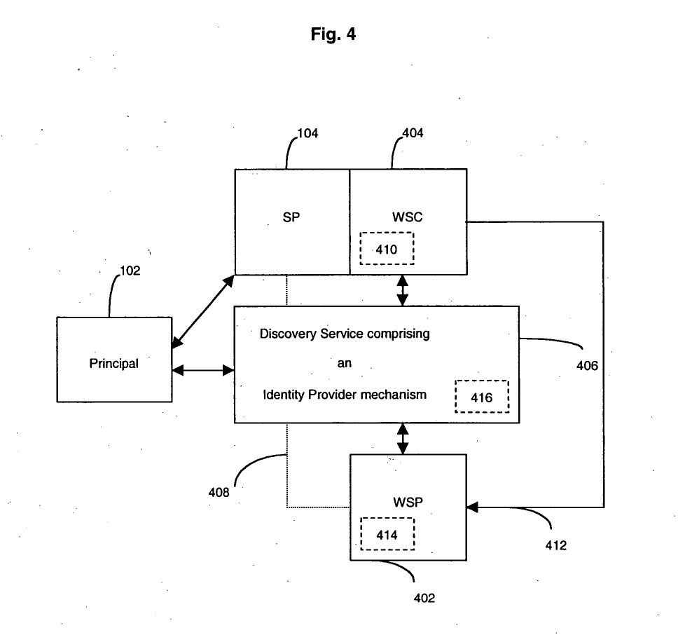

A preferred embodiment can be described with reference to FIG. 4. A Web service provider (WSP) 402 typically is configured in such as way such that a calling Web Service Client (WSC) 404 must prove that the Principal 102 requesting the service has a live authenticated session with the WSC 404. Such policy is enforced by either the WSP 402 or a discovery service (DS) module 406. As an example, consider the WSC 404 as a subscription service and the WSP 402 as a user's wallet application. It is assumed that the service provider 104, the WSC 404, and the WSP 402 all had previously agreed to work with each other 408.

In one embodiment of the invention, during a request for performing a transaction and to prove user presence, the WSC 404 comprises a previously attained assertion signed by the identity provider (IDP) mechanism 406, wherein the assertion contains a statement 410 that the user, Principal 102, is authenticated during the registration period, but does not have a live authenticated session in progress.

This statement 410 logically comprises at least the following four pieces of information:

The system entity making the assertion (typically the IDP);

The system entity making the request (the WSC);

The system entity relying on the assertion (the WSP); and

The name identifier of the Principal in the namespace of the IDP→WSP (the relying party).

The WSC 404 obtains this user presence statement 410 by a variety of means; two examples follow.

First, in one embodiment, the user presence statement 410 is included in an extended assertion, e.g. a ticket, that is given to the service provider 104 at the time of authentication (as described above).

Second, in another example, the WSC 404 can present to the DS 406 a service assertion it obtained from another system entity (likely another WSC) that contains a user presence statement. The DS will then issue a new service assertion containing a new user presence statement. This allows for a WSP to also become a WSC and invoke a user service at another WSP and still prove user presence.

In another equally preferred embodiment of the invention, the discovery service 406 doesn't send the ticket 410 to the WSC 404. Instead, the discovery service 406 itself records and stores the user statement information 416 for future use by the WSC 404. The stored user statement information 416 could be in the form of a table, for example.

In another equally preferred embodiment of the invention, the WSP 402 stores the ticket 414. When the WSC 404 makes a request to use the WSP 402, the WSC 404 contacts the DS 406 first which tells the WSC 404 where to go for the service 412, i.e. to the WSP 402. Then, the WSP 402 uses the ticket 414 to check that the WSC 404 does indeed have permission to request the transaction in the absence of the user.

An Alternate Means for Registration

It should be appreciated that in the preferred embodiment of the invention, the WSC 404 comprises means for first testing a request to the WSP 402 while the user is still present. That is, the WSC 404 can make a request for a transaction indicating that the request is just a test, such as, by having a test flag turned on, for example. Then, in this embodiment of the invention, either or both the DS 406 and the WSP 402 can perform real-time consent informational data collection from the user without having actually performed the particular transaction. In this way, the WSC 404 is confident and comfortable that such operation will succeed (although it may fail for other reasons) when the user is not present at a later point in time.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. An apparatus for proving authentication when a user is not present, said apparatus comprising:
a Web service client coupled to a service provider;
a Web service provider; and
a discovery service;
wherein:
said Web service client, said service provider, said Web service provider, and said discovery service agree to work with each other; and
said Web service provider is configured in such a way such that said calling Web service client must prove that it has permission to request a service from said Web service provider when a live authenticated session of said user with said Web service client is not present.

2. The apparatus of claim 1, wherein said Web service client comprises an assertion, said assertion comprising a statement that said user has an authenticated session.

3. The apparatus of claim 2, wherein said assertion is signed by an authority.

4. The apparatus of claim 3, wherein said authority is an identity provider of said discovery service.

5. The apparatus of claim 2, wherein said statement comprises, but is not limited to, the following information:
a system entity that made said assertion;
a system entity making a request;
a system entity relying on said assertion; and
a name identifier of said user in a namespace of said system entity that made said assertion to said system entity relying on said assertion.

6. The apparatus of claim 5, wherein said system entity making said assertion is an identity provider of said discovery service.

7. The apparatus of claim 5, wherein said system entity making a request is said Web service client.

8. The apparatus of claim 5, wherein said system entity relying on said assertion is said Web service provider.

9. The apparatus of claim 5, wherein said asserting party is said Web service client and said relying party is said Web service provider.

10. The apparatus of claim 2, wherein said statement is included in an extended assertion that is given to said service provider at time of authentication.

11. The apparatus of claim 1, further comprising:
means for said Web service client presenting to said discovery service a service assertion obtained from a second system entity, wherein said service assertion comprises a user presence statement; and
means for said discovery service issuing a new service assertion comprising a new user presence statement, said new service assertion and said new user presence statement associated with said second system entity.

12. The apparatus of claim 11, wherein said second system entity is a second Web service client.

13. The apparatus of claim 1, further comprising means for said discovery service recording and storing user statement information.

14. The apparatus of claim 13, wherein said recorded and stored user statement information is in the form of a table.

15. The apparatus of claim 1, further comprising means for said Web service provider storing a ticket for checking said permission to request a service.

16. The apparatus of claim 1, further comprising means for testing a request to said Web service provider while a user is still present, wherein either or both said discovery service and said Web service provider can perform real-time consent informational data collection from a user without having actually performed a particular transaction.

17. A method for proving authentication when a user is not present, said method comprising the steps of:
providing a Web service client coupled to a service provider;
providing a Web service provider; and
providing a discovery service;
wherein:
said Web service client, said service provider, said Web service provider, and said discovery service agree to work with each other; and
said Web service provider is configured in such a way such that said calling Web service client must prove that it has permission to request a service from said Web service provider when a live authenticated session of said user with said Web service client is not present.

18. The method of claim 17, wherein said Web service client comprises an assertion, said assertion comprising a statement that said user has an authenticated session.

19. The method of claim 18, wherein said assertion is signed by an authority.

20. The method of claim 19, wherein said authority is an identity provider of said discovery service.

21. The method of claim 18, wherein said statement comprises, but is not limited to, the following information:
a system entity that made said assertion;
a system entity making a request;
a system entity relying on said assertion; and
a name identifier of said user in a namespace of said system entity that made said assertion to said system entity relying on said assertion.

22. The method of claim 21, wherein said system entity making said assertion is an identity provider of said discovery service.

23. The method of claim 21, wherein said system entity making a request is said Web service client.

24. The method of claim 21, wherein said system entity relying on said assertion is said Web service provider.

25. The method of claim 21, wherein said asserting party is said Web service client and said relying party is said Web service provider.

26. The method of claim 18, wherein said statement is included in an extended assertion that is given to said service provider at time of authentication.

27. The method of claim 17, further comprising the steps of:
said Web service client presenting to said discovery service a service assertion obtained from a second system entity, wherein said service assertion comprises a user presence statement; and
said discovery service issuing a new service assertion comprising a new user presence statement, said new service assertion and said new user presence statement associated with said second system entity.

28. The method of claim 27, wherein said second system entity is a second Web service client.

29. The method of claim 17, further comprising the step of said discovery service recording and storing user statement information.

30. The method of claim 20, wherein said recorded and stored user statement information is in the form of a table.

31. The method of claim 17, further comprising the step of said Web service provider storing a ticket for checking said permission to request a service.

32. The method of claim 17, further comprising the step of testing a request to said Web service provider while a user is still present, wherein either or both said discovery service and said Web service provider can perform real-time consent informational data collection from a user without having actually performed a particular transaction.

33. A method for invoking authenticated transactions on behalf of a user when the user is not present, said method comprising the steps of:
a service provider, at a time when a user is present, asking the user if said service provider can perform a particular transaction at a later point in time when the user is not present, wherein if the user indicates yes, then said service provider sending a notification to register with any of, or both of:
a trusted discovery service; and
a Web service provider that performs said particular transaction;
wherein while the user is still present, the user can be asked to provide informational content related to said particular transaction; and
for invocation, said service provider making a request of the Web service provider to perform said particular transaction.

34. The method of claim 33, further comprising the step of a discovery service checking if the user gave permission for contacting said Web service provider when the user is not present, and if permission is granted, allowing control to go to said Web service provider.

35. The method of claim 33, further comprising any of the steps of said Web service provider:
trusting said discovery service performed checking for permission and accepting that if said discovery service indicates the user gave permission, then said Web service provider performing said particular transaction; and
said Web service provider deciding to perform checking for permission, and subsequently performing said particular transaction if said Web service provider determines permission is granted.

36. The method of claim 33, further comprising the step of providing a user capability of reviewing and modifying stored permissions.

37. The method of claim 33, further comprising the step of providing robust security by having trust kept centrally in said discovery service.

38. The method of claim 33, further comprising said discovery service supporting a plurality of different types of Web service providers.

39. An apparatus for invoking authenticated transactions on behalf of a user when the user is not present, said method comprising:
providing a service provider, at a time when a user is present, asking the user if said service provider can perform a particular transaction at a later point in time when the user is not present, wherein if the user indicates yes, then said service provider sending a notification to register with any of, or both of:
a trusted discovery service; and
a Web service provider that performs said particular transaction;
wherein while the user is still present, the user can be asked to provide informational content related to said particular transaction; and
for invocation, means for said service provider making a request of the Web service provider to perform said particular transaction.

40. The apparatus of claim 39, further comprising means for a discovery service checking if the user gave permission for contacting said Web service provider when the user is not present, and if permission is granted, allowing control to go to said Web service provider.

41. The apparatus of claim 39, further comprising means for any of said Web service provider:
trusting said discovery service performed checking for permission and accepting that if said discovery service indicates the user gave permission, then said Web service provider performing said particular transaction; and
said Web service provider deciding to perform checking for permission, and subsequently performing said particular transaction if said Web service provider determines permission is granted.

42. The apparatus of claim 39, further comprising means for providing a user capability of reviewing and modifying stored permissions.

43. The apparatus of claim 39, further comprising means for providing robust security by having trust kept centrally in said discovery service.

44. The apparatus of claim 39, further comprising means for said discovery service supporting a plurality of different types of Web service providers.
